(19) United States
(12) Patent Application Publication
(10) Pub. No.: US 2026/0187888 A1
(43) Pub. Date: Jul. 2, 2026

(54) HIGH-RESOLUTION LOW-NOISE VOLUME-OF-INTEREST IMAGING IN HELICAL COMPUTED TOMOGRAPHY USING DEEP LEARNING

(71) Applicant: Mayo Foundation for Medical Education and Research, Rochester, MN (US)

(72) Inventors: Lifeng Yu, Byron, MN (US); Zhongxing Zhou, Rochester, MN (US); Cynthia H. McCollough, Byron, MN (US); Christian W. Cox, Rochester, MN (US)

(21) Appl. No.: 19/131,915

(22) PCT Filed: Nov. 27, 2023
(86) PCT No.: PCT/US2023/081198

§ 371 Date: May 21, 2025

Related U.S. Application Data
(60) Provisional application No. 63/385,029, filed on Nov. 27, 2022.

(51) Int. Cl. G06T 12/30

(52) U.S. Cl. CPC G06T 12/30; G06T 2211/432; G06T 2211/441

(57) ABSTRACT

Volume-of-interest (“VOI”) imaging with computed tomography (“CT”) (e.g., VOI CT in a helical or axial acquisition geometry) is used to produce higher resolution, lower noise images with less radiation dose than is required for equivalent resolution and noise characteristics using standard data acquisitions. Truncation artifacts introduced by the VOI imaging are removed or otherwise reduced using a deep learning model that is trained to remove truncation artifacts from VOI images.

### BACKGROUND

High spatial resolution computed tomography (“CT”) can include photon-counting-detector (“PCD”)-CT and energy-integrated-detector (“EID”)-CT with added grid/comb filter(s) or reduced detector pixel sizes. In general, high spatial resolution CT has important applications in many clinical areas, including lung, musculoskeletal, inner ear, and cardiovascular imaging. However, the higher spatial resolution of these imaging systems and techniques also result in increased image noise that limits the clinical benefits of the high-resolution imaging. Without successful suppression of image noise, the benefit of high spatial resolution imaging is limited. Radiation dose can be increased to reduce image noise, but with increased risk of radiation exposure to the patients. Various iterative reconstruction or denoising methods have been used to reduce image noise, but these methods risk being too aggressive and sacrificing image details. There remains a need for reducing noise in high spatial resolution CT imaging without sacrificing the higher resolution or exposing the patient to increased radiation dose.

### SUMMARY OF THE DISCLOSURE

The present disclosure addresses the aforementioned drawbacks by providing a method for generating images of a volume-of-interest (“VOI”) in a subject using a computed tomography (“CT”). The method includes accessing VOI image data with a computer system, where the VOI image data have been acquired from the VOI in the subject using the CT system, and where the VOI image data include truncation artifacts. A machine learning model (e.g., a neural network) is also accessed with the computer system, where the machine learning model has been trained on training data to remove truncation artifacts from VOI images. The VOI image data are input to the machine learning model using the computer system, generating output data as artifact-reduced VOI images that depict the VOI in the subject with reduced truncation artifacts as compared to the VOI image data. The artifact-reduced VOI images can be displayed to a user and/or stored for later use using the computer system.

The foregoing and other aspects and advantages of the present disclosure will appear from the following description. In the description, reference is made to the accompanying drawings that form a part hereof, and in which there is shown by way of illustration one or more embodiments. These embodiments do not necessarily represent the full scope of the invention, however, and reference is therefore made to the claims and herein for interpreting the scope of the invention.

### BRIEF DESCRIPTION OF THE DRAWINGS

FIG. 1 shows a schematic of VOI helical CT for high-resolution low-noise imaging. Example images with regular and high resolution (but with increased noise) acquired from standard full FOV imaging at routine dose level are shown in the first row. Example images from VOI helical CT imaging before and after truncation artifact correction are shown in the second row.

FIG. 2 is a flowchart setting forth the steps of an example method for reducing truncation artifacts in a VOI image using a trained deep learning model.

FIG. 3 is a flowchart setting forth the steps of an example method for training a deep learning model (e.g., a neural network) to remove truncation artifacts from a VOI image.

FIG. 4 is an example neural network architecture for VOI-Net, which can be trained to remove truncation artifacts from a VOI image.

FIG. 5 illustrates axial and coronal views of images within a VOI acquired from an original full FOV imaging (1st column), VOI imaging at the same total dose before (2nd column) and after VOI-Net correction (3rd column), and the reference image (4th column). The reference image was cropped from full FOV images at 3.5 times the routine dose level. The images in the 3rd row are corresponding to the cross section indicated by the dashed lines in the 2nd row. The display window/level is (−400, 1500) HU for the 1st and 2nd row, (60, 400) HU for the 3rd row. The images marked *×10 indicates that the window level is 4000. The yellow arrows in the figure point to small linear reticulations associated with ground-glass opacity.

FIG. 6 depicts the example full FOV image with a red circle indicating the target VOI corresponding to FIG. 5. The display window/level is (−400, 1500) HU.

FIG. 7 is a block diagram of an example system for reducing artifacts in VOI images.

FIG. 8 is a block diagram of example components that can implement the system of FIG. 7.

### DETAILED DESCRIPTION

Described here are systems and methods for volume-of-interest (“VOI”) imaging in helical computed tomography (“CT”) that use deep learning to achieve high spatial resolution and low noise imaging. Advantageously, using these systems and methods a routine radiation dose can be used to acquire images with higher spatial resolution and lower noise in the targeted VOI; such as, at levels that are only typically achievable only at a much higher radiation dose in a standard full field-of-view (“FOV”) scan. Higher spatial resolution is often desired in a small region-of-interest in many diagnostic exams. In these instances, the disclosed systems and methods for VOI imaging can improve spatial resolution in the targeted region without increasing radiation dose and image noise.

Advantageously, VOI imaging focuses the radiation dose primarily on a target volume and hence can improve the image quality within the VOI. However, transverse directional projection truncation is often introduced in the data acquired from VOI scans, which can result in cupping artifacts in images that are reconstructed by traditional analytic and iterative reconstruction algorithms. The systems and methods described in the present disclosure make use of deep learning to correct for these truncation artifacts in helical CT VOI scans. Using this strategy, the spatial resolution in the targeted VOI can be improved at the same routine radiation dose without increasing image noise, and without the resulting images suffering from truncation artifacts.

As a non-limiting example, high-resolution images of a patient with interstitial lung disease originally scanned on a photon-counting-detector (“PCD”)-CT were used to assess the performance of the developed deep-learning-based helical VOI imaging method. Radiation dose level to achieve equivalent image quality in a regular full FOV scan was calculated. The results demonstrated that the proposed method could generate images at a 10-cm targeted VOI with the spatial resolution and noise that are only achievable by increasing the radiation dose to a level as high as 3.5 times that in a standard full FOV CT scan.

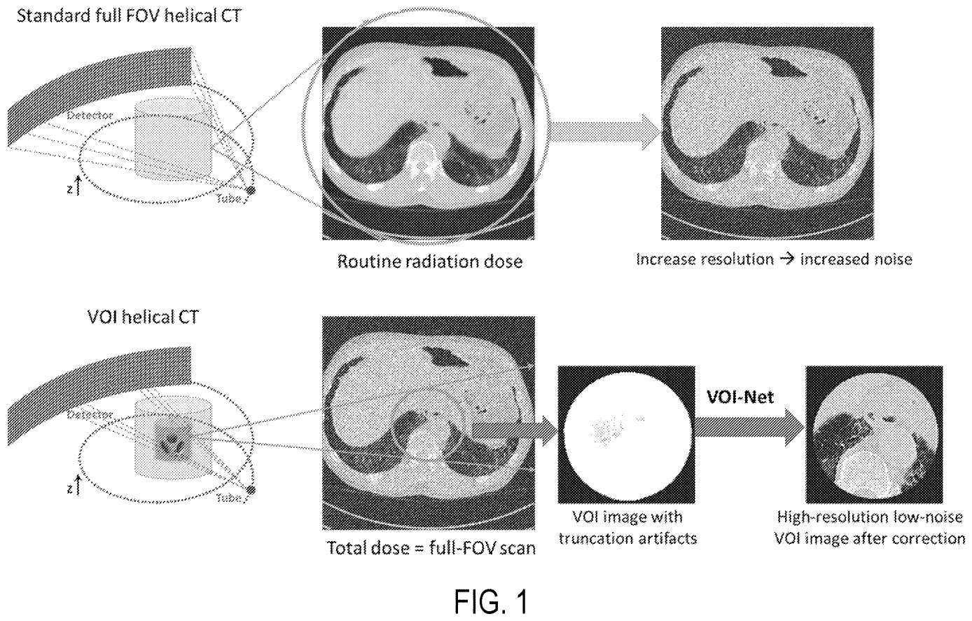

Spatial resolution in CT can be increased by using a sharp kernel or a thinner slice thickness. New technologies, such as PCD-CT with small detector pixels, can further enhance the best achievable spatial resolution, which typically leads to drastically increased image noise, as shown in the top row of FIG. 1. VOI imaging with radiation dose primarily focused on the target VOI can reduce the noise within the VOI, but it suffers from truncation artifacts. By using a deep convolutional neural network (referred to here as VOI-Net) for truncation artifacts correction, both high resolution and low noise at the VOI can be achieved at the same radiation dose, as shown in the bottom row of FIG. 1.

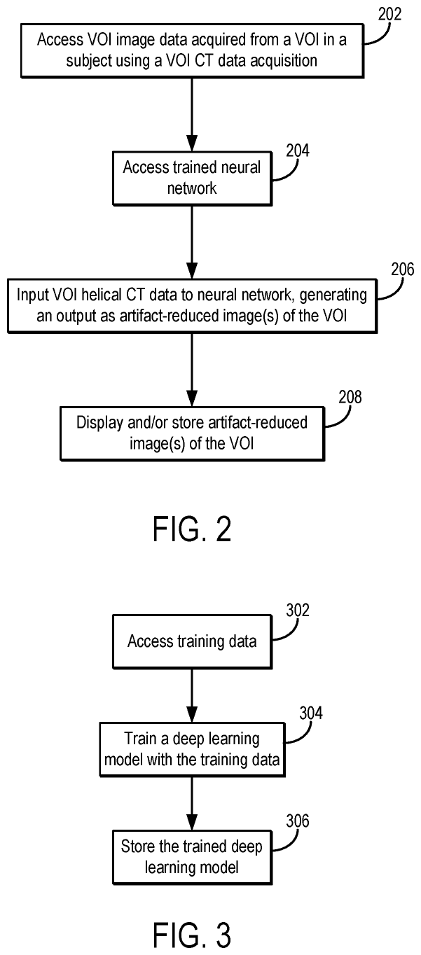

Referring now to FIG. 2, a flowchart is illustrated as setting forth the steps of an example method for generating high-resolution, low-noise images of a volume-of-interest in a subject from data acquired using a CT system. In some implementations, the data may be acquired using a VOI helical CT acquisition. In some other implementations, the data may be acquired using an axial acquisition geometry without patient table motion. Additionally or alternatively, the data may be acquired with an x-ray exposure that is targeted on the VOI, such that the acquired data will have a high spatial resolution and low image noise. As will be described, a neural network or other machine learning algorithm takes a VOI image having truncation artifacts as input data and generates an artifact-reduced VOI image as output data. As an example, the artifact-reduced VOI image can maintain the high-resolution and low-noise properties of the input VOI image, while removing or otherwise reducing the truncation artifacts caused by the VOI helical CT acquisition.

The method includes accessing VOI image data with a computer system, as indicated at step 202. Accessing the VOI image data may include retrieving such data from a memory or other suitable data storage device or medium. Additionally or alternatively, accessing the VOI image data may include acquiring such data with a CT system and transferring or otherwise communicating the data to the computer system, which may be a part of the CT system.

The VOI image data may include images reconstructed from projection data acquired from a VOI in a subject using a VOI helical CT acquisition, or other VOI CT acquisition. As one alternative example, the VOI image data may be acquired using an axial acquisition geometry without moving the patient table during the data acquisition. These VOI images can have high spatial resolution and low noise as compared to standard CT images acquired with much higher radiation doses. For instance, the VOI image data can be acquired using an x-ray exposure that is targeted on the VOI, such that the VOI image data will have high spatial resolution and reduced image noise. Advantageously, because the VOI image data are obtained from a smaller VOI in the subject, lower radiation dose can be used while maintaining high spatial resolution and low noise in the VOI. As described above, the VOI images will suffer from truncation artifacts that can be removed from the images using the systems and methods described in the present disclosure.

Additionally or alternatively, the VOI image data may include raw projection data acquired from a VOI in a subject using a VOI helical CT acquisition, or other VOI CT acquisition. VOI images can then be reconstructed from the raw projection data, resulting in high-resolution, low-noise VOI images that suffer from truncation artifacts. The VOI images can be reconstructed using any suitable reconstruction algorithm, including traditional analytical reconstruction algorithms (e.g., filtered backprojection), iterative reconstruction algorithms, and the like.

A trained neural network (or other suitable machine learning algorithm) is then accessed with the computer system, as indicated at step 204. In general, the neural network is trained, or has been trained, on training data in order to remove truncation artifacts from VOI images.

Accessing the trained neural network may include accessing network parameters (e.g., weights, biases, or both) that have been optimized or otherwise estimated by training the neural network on training data. In some instances, retrieving the neural network can also include retrieving, constructing, or otherwise accessing the particular neural network architecture to be implemented. For instance, data pertaining to the layers in the neural network architecture (e.g., number of layers, type of layers, ordering of layers, connections between layers, hyperparameters for layers) may be retrieved, selected, constructed, or otherwise accessed.

An artificial neural network generally includes an input layer, one or more hidden layers (or nodes), and an output layer. Typically, the input layer includes as many nodes as inputs provided to the artificial neural network. The number (and the type) of inputs provided to the artificial neural network may vary based on the particular task for the artificial neural network.

The input layer connects to one or more hidden layers. The number of hidden layers varies and may depend on the particular task for the artificial neural network. Additionally, each hidden layer may have a different number of nodes and may be connected to the next layer differently. For example, each node of the input layer may be connected to each node of the first hidden layer. The connection between each node of the input layer and each node of the first hidden layer may be assigned a weight parameter. Additionally, each node of the neural network may also be assigned a bias value. In some configurations, each node of the first hidden layer may not be connected to each node of the second hidden layer. That is, there may be some nodes of the first hidden layer that are not connected to all of the nodes of the second hidden layer. The connections between the nodes of the first hidden layers and the second hidden layers are each assigned different weight parameters. Each node of the hidden layer is generally associated with an activation function. The activation function defines how the hidden layer is to process the input received from the input layer or from a previous input or hidden layer. These activation functions may vary and be based on the type of task associated with the artificial neural network and also on the specific type of hidden layer implemented.

Each hidden layer may perform a different function. For example, some hidden layers can be convolutional hidden layers which can, in some instances, reduce the dimensionality of the inputs. Other hidden layers can perform statistical functions such as max pooling, which may reduce a group of inputs to the maximum value; an averaging layer; batch normalization; and other such functions. In some of the hidden layers each node is connected to each node of the next hidden layer, which may be referred to then as dense layers. Some neural networks including more than, for example, three hidden layers may be considered deep neural networks.

The last hidden layer in the artificial neural network is connected to the output layer. Similar to the input layer, the output layer typically has the same number of nodes as the possible outputs.

The VOI image data are then input to the one or more trained neural networks, generating output as artifact-reduced VOI images, as indicated at step 206. The artifact-reduced VOI images generated by inputting the VOI image data to the trained neural network(s) can then be displayed to a user, stored for later use or further processing, or both, as indicated at step 208.

Referring now to FIG. 3, a flowchart is illustrated as setting forth the steps of an example method for training one or more neural networks (or other suitable machine learning algorithms) on training data, such that the one or more neural networks are trained to receive VOI images having truncation artifacts as input data in order to generate artifact-reduced VOI images, in which the truncation artifacts in the input VOI images have been removed or otherwise reduced.

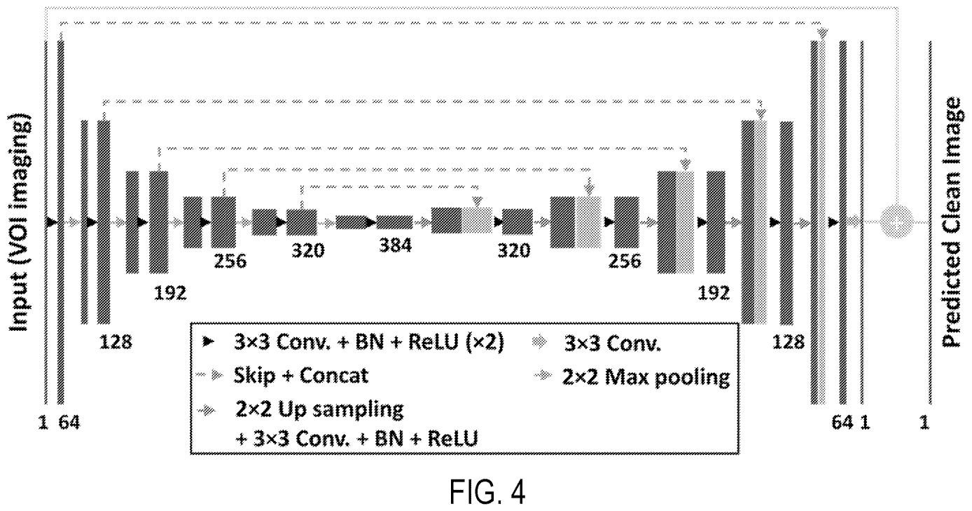

In general, the neural network(s) can implement any number of different neural network architectures. For instance, the neural network(s) could implement a convolutional neural network, a residual neural network, or the like. Alternatively, the neural network(s) could be replaced with other suitable machine learning or artificial intelligence algorithms, such as those based on supervised learning, unsupervised learning, deep learning, ensemble learning, dimensionality reduction, and so on. An example neural network architecture that can be used by the systems and methods described in the present disclosure is shown in FIG. 4. In this example, the VOI-Net was implemented using a modified 6-layer residual U-Net for the neural network architecture.

The method includes accessing training data with a computer system, as indicated at step 302. Accessing the training data may include retrieving such data from a memory or other suitable data storage device or medium. Alternatively, accessing the training data may include acquiring such data with a CT system and transferring or otherwise communicating the data to the computer system, which may be a part of the CT system.

In general, the training data can include pairs of images with and without truncation artifacts. As a non-limiting example, the training pairs can images reconstructed from projections with and without truncations. In an example implementation, a total of 512,000 matched image patches (with and without truncation, matrix size: 192×192) were used as a training data set, while 64,000 matched patches were selected to validate the performance of the trained models.

The method can include assembling training data from CT images using a computer system. This step may include assembling the CT images into an appropriate data structure on which the neural network or other machine learning algorithm can be trained. Assembling the training data may include selecting matched image patches from artifact-free images and artifact-corrupted imaged.

As a non-limiting example, a multi-slice helical CT geometry can be used to generate the projection data (e.g., with a detector configuration: 736 channels×16 rows, detector width 1.0947 mm and height 1.2856 mm, source-isocenter distance 595.0 mm, source-detector distance 1085.6 mm, helical pitch 0.6, original scan FOV 50 cm) with and without truncations. The truncated projections can be generated by using a narrowed beam collimation (e.g., 148 channels) targeting on a VOI of 10-cm diameter. Routine-dose CT images can be used to generate helical projections with and without truncation for model training. For instance, these images can be reconstructed by filtered backprojection (“FBP”) with a reconstruction FOV of 340 mm and a medium smooth kernel (B30). The total radiation dose absorbed by a patient using VOI imaging was kept the same as that in the full FOV scan without truncation.

In an example implementation, the generated helical CT projection data for training and testing were all reconstructed with FBP using an open-source reconstruction software (FreeCT) with a “sharp” kernel. All of the FreeCT reconstructed images had 512×512 in-plane pixels, and 340 mm FOV for the full FOV reconstruction and 100 mm FOV for the VOI reconstruction. The total energy imparted to the patient when employing standard full FOV CT scan at routine dose level was calculated, and then the same total energy was focused primarily on the target volume during VOI imaging.

One or more neural networks (or other suitable machine learning algorithms) are trained on the training data, as indicated at step 304. In general, the neural network can be trained by optimizing network parameters (e.g., weights, biases, or both) based on minimizing a loss function. As one non-limiting example, the loss function may be a mean squared error loss function.

Training a neural network may include initializing the neural network, such as by computing, estimating, or otherwise selecting initial network parameters (e.g., weights, biases, or both). During training, an artificial neural network receives the inputs for a training example and generates an output using the bias for each node, and the connections between each node and the corresponding weights. For instance, training data can be input to the initialized neural network, generating output as artifact-reduced VOI images. The artificial neural network then compares the generated output with the actual output of the training example in order to evaluate the quality of the artifact-reduced VOI images. For instance, the artifact-reduced VOI images can be passed to a loss function to compute an error. The current neural network can then be updated based on the calculated error (e.g., using backpropagation methods based on the calculated error). For instance, the current neural network can be updated by updating the network parameters (e.g., weights, biases, or both) in order to minimize the loss according to the loss function. The training continues until a training condition is met. The training condition may correspond to, for example, a predetermined number of training examples being used, a minimum accuracy threshold being reached during training and validation, a predetermined number of validation iterations being completed, and the like. When the training condition has been met (e.g., by determining whether an error threshold or other stopping criterion has been satisfied), the current neural network and its associated network parameters represent the trained neural network. Different types of training processes can be used to adjust the bias values and the weights of the node connections based on the training examples. The training processes may include, for example, gradient descent, Newton's method, conjugate gradient, quasi-Newton, Levenberg-Marquardt, among others.

The artificial neural network can be constructed or otherwise trained based on training data using one or more different learning techniques, such as supervised learning, unsupervised learning, reinforcement learning, ensemble learning, active learning, transfer learning, or other suitable learning techniques for neural networks. As an example, supervised learning involves presenting a computer system with example inputs and their actual outputs (e.g., categorizations). In these instances, the artificial neural network is configured to learn a general rule or model that maps the inputs to the outputs based on the provided example input-output pairs.

In an example implementation, a deep convolutional neural network (e.g., the VOI-Net shown in FIG. 4) was trained to correct for the truncation artifacts resulting from VOI imaging. The Adam optimizer with a descending learning rate from 0.001 to 0.00001 was used to train VOI-Net with a mini batch of 16 image patches for each iteration. Pixel-wise mean-square-error between VOI-Net output and an image reconstructed from projection data without truncation was employed as the loss function during optimization. The VOI-Net training was performed on a NVIDIA Tesla M40 GPU with 12 GB memory. During the testing phase, the trained VOI-Net was applied to reconstructed PCD images from truncated helical projection data to suppress truncation artifacts. The image quality of the VOI was evaluated by calculating the root mean square error (“RMSE”) using the testing data within the VOI from the full FOV reconstruction for reference.

The one or more trained neural networks are then stored for later use, as indicated at step 306. Storing the neural network(s) may include storing network parameters (e.g., weights, biases, or both), which have been computed or otherwise estimated by training the neural network(s) on the training data. Storing the trained neural network(s) may also include storing the particular neural network architecture to be implemented. For instance, data pertaining to the layers in the neural network architecture (e.g., number of layers, type of layers, ordering of layers, connections between layers, hyperparameters for layers) may be stored.

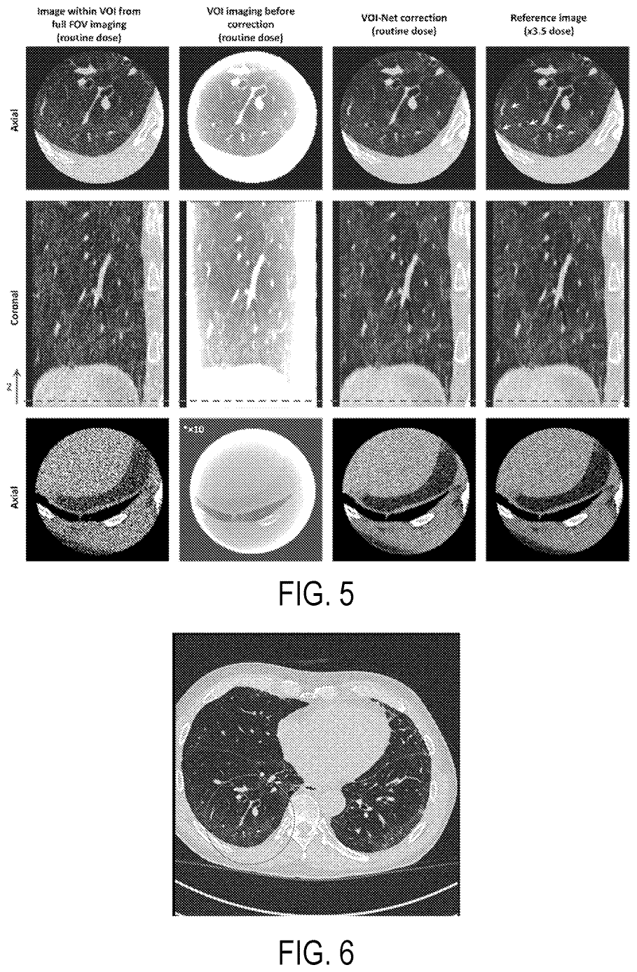

The results from an example implementation of the VOI-Net described in the present disclosure are shown in FIG. 5. A corresponding full FOV chest image from a testing patient case, which was reconstructed by FreeCT with the “sharp” kernel at routine dose level, as shown in FIG. 6. The region for VOI imaging is marked with a red circle in FIG. 6. Results of VOI imaging at the same total dose before and after VOI-Net correction are displayed in FIG. 5. The image within the VOI acquired from the original routine dose full FOV imaging (FIG. 6) is shown for comparison. The image cropped from full FOV images at 3.5 times the routine dose level is shown as a reference.

As can be observed in FIG. 5, the truncation artifacts were accurately corrected by the VOI-Net, with the root mean square error (“RMSE”) of 7.25±4.92 HU across all slices in the processed CT volume. Compared to the original full FOV images acquired with the same total dose, the VOI images after correction lowered the image noise in lung region from 87.4 HU to 42.1 HU and improved the contrast of ground-glass opacity. This noise level within the VOI is equivalent to that when a dose level 3.5 times higher than the routine dose is used. Ground-glass opacity is seen peripherally in the right lower lung lobe of the image from the original routine dose full FOV imaging, whereas small linear reticulations associated with ground-glass opacity are clearly observed in the image with VOI-Net correction acquired with the same total dose. The overall higher image quality of deep learning-based VOI imaging may contribute to increased confidence in the diagnosis of interstitial lung disease and other pathological conditions. The effectiveness of the systems and methods described in the present disclosure is also verified by the image quality in the liver, as indicated by the last row of FIG. 5.

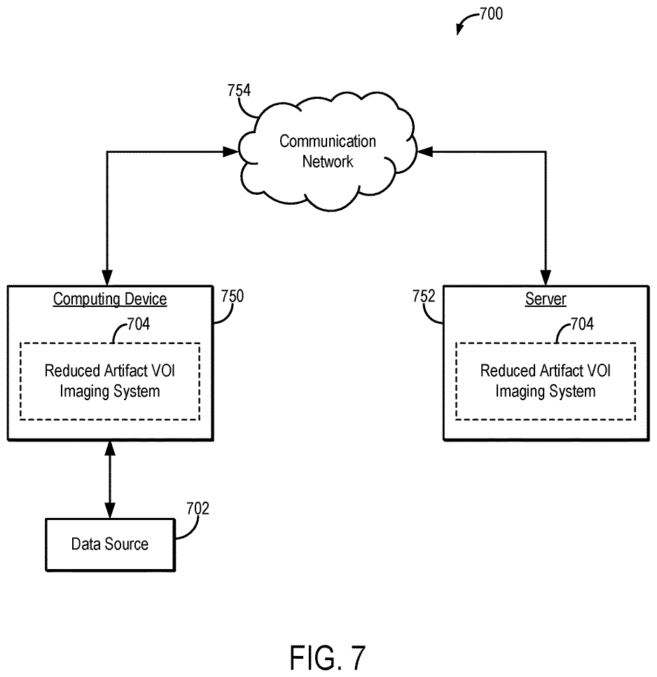

Referring now to FIG. 7, an example of a system 700 for deep learning-based VOI helical CT imaging in accordance with some embodiments of the systems and methods described in the present disclosure is shown. As shown in FIG. 7, a computing device 750 can receive one or more types of data (e.g., VOI image data) from data source 702. In some embodiments, computing device 750 can execute at least a portion of a reduced artifact VOI imaging system 704 to generate artifact-reduced VOI images from data received from the data source 702.

Additionally or alternatively, in some embodiments, the computing device 750 can communicate information about data received from the data source 702 to a server 752 over a communication network 754, which can execute at least a portion of the reduced artifact VOI imaging system 704. In such embodiments, the server 752 can return information to the computing device 750 (and/or any other suitable computing device) indicative of an output of the reduced artifact VOI imaging system 704.

In some embodiments, computing device 750 and/or server 752 can be any suitable computing device or combination of devices, such as a desktop computer, a laptop computer, a smartphone, a tablet computer, a wearable computer, a server computer, a virtual machine being executed by a physical computing device, and so on. The computing device 750 and/or server 752 can also reconstruct images from the data.

In some embodiments, data source 702 can be any suitable source of data (e.g., measurement data, images reconstructed from measurement data, processed image data), such as a CT system, another computing device (e.g., a server storing measurement data, images reconstructed from measurement data, processed image data), and so on. In some embodiments, data source 702 can be local to computing device 750. For example, data source 702 can be incorporated with computing device 750 (e.g., computing device 750 can be configured as part of a device for measuring, recording, estimating, acquiring, or otherwise collecting or storing data). As another example, data source 702 can be connected to computing device 750 by a cable, a direct wireless link, and so on. Additionally or alternatively, in some embodiments, data source 702 can be located locally and/or remotely from computing device 750, and can communicate data to computing device 750 (and/or server 752) via a communication network (e.g., communication network 754).

In some embodiments, communication network 754 can be any suitable communication network or combination of communication networks. For example, communication network 754 can include a Wi-Fi network (which can include one or more wireless routers, one or more switches, etc.), a peer-to-peer network (e.g., a Bluetooth network), a cellular network (e.g., a 3G network, a 4G network, etc., complying with any suitable standard, such as CDMA, GSM, LTE, LTE Advanced, WiMAX, etc.), other types of wireless network, a wired network, and so on. In some embodiments, communication network 754 can be a local area network, a wide area network, a public network (e.g., the Internet), a private or semi-private network (e.g., a corporate or university intranet), any other suitable type of network, or any suitable combination of networks. Communications links shown in FIG. 7 can each be any suitable communications link or combination of communications links, such as wired links, fiber optic links, Wi-Fi links, Bluetooth links, cellular links, and so on.

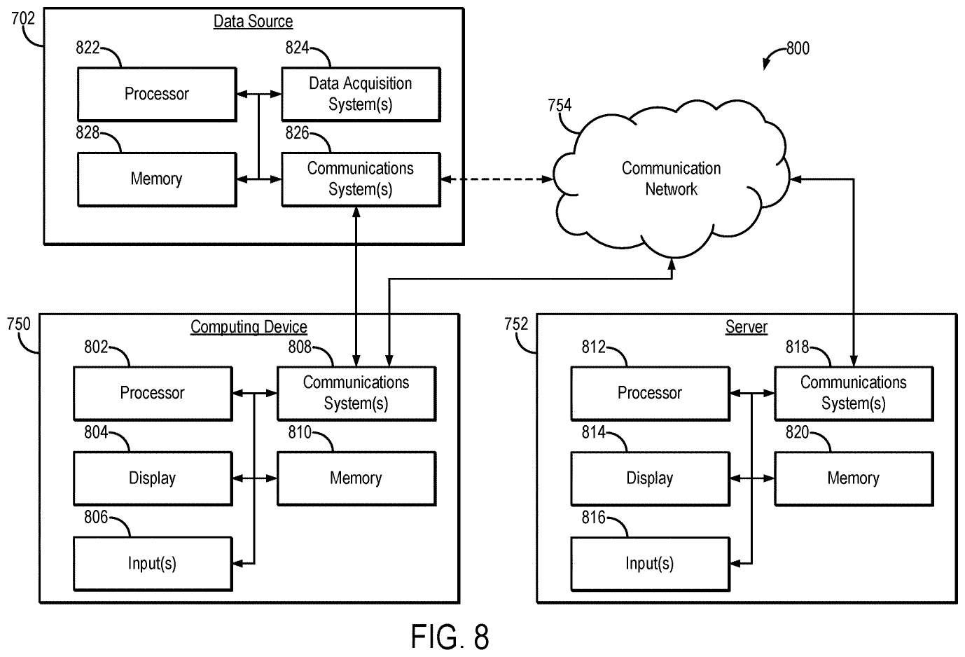

Referring now to FIG. 8, an example of hardware 800 that can be used to implement data source 702, computing device 750, and server 752 in accordance with some embodiments of the systems and methods described in the present disclosure is shown.

As shown in FIG. 8, in some embodiments, computing device 750 can include a processor 802, a display 804, one or more inputs 806, one or more communication systems 808, and/or memory 810. In some embodiments, processor 802 can be any suitable hardware processor or combination of processors, such as a central processing unit (“CPU”), a graphics processing unit (“GPU”), and so on. In some embodiments, display 804 can include any suitable display devices, such as a liquid crystal display (“LCD”) screen, a light-emitting diode (“LED”) display, an organic LED (“OLED”) display, an electrophoretic display (e.g., an “e-ink” display), a computer monitor, a touchscreen, a television, and so on. In some embodiments, inputs 806 can include any suitable input devices and/or sensors that can be used to receive user input, such as a keyboard, a mouse, a touchscreen, a microphone, and so on.

In some embodiments, communications systems 808 can include any suitable hardware, firmware, and/or software for communicating information over communication network 754 and/or any other suitable communication networks. For example, communications systems 808 can include one or more transceivers, one or more communication chips and/or chip sets, and so on. In a more particular example, communications systems 808 can include hardware, firmware, and/or software that can be used to establish a Wi-Fi connection, a Bluetooth connection, a cellular connection, an Ethernet connection, and so on.

In some embodiments, memory 810 can include any suitable storage device or devices that can be used to store instructions, values, data, or the like, that can be used, for example, by processor 802 to present content using display 804, to communicate with server 752 via communications system(s) 808, and so on. Memory 810 can include any suitable volatile memory, non-volatile memory, storage, or any suitable combination thereof. For example, memory 810 can include random-access memory (“RAM”), read-only memory (“ROM”), electrically programmable ROM (“EPROM”), electrically erasable ROM (“EEPROM”), other forms of volatile memory, other forms of non-volatile memory, one or more forms of semi-volatile memory, one or more flash drives, one or more hard disks, one or more solid state drives, one or more optical drives, and so on. In some embodiments, memory 810 can have encoded thereon, or otherwise stored therein, a computer program for controlling operation of computing device 750. In such embodiments, processor 802 can execute at least a portion of the computer program to present content (e.g., images, user interfaces, graphics, tables), receive content from server 752, transmit information to server 752, and so on. For example, the processor 802 and the memory 810 can be configured to perform the methods described herein (e.g., the method of FIG. 2, the method of FIG. 3).

In some embodiments, server 752 can include a processor 812, a display 814, one or more inputs 816, one or more communications systems 818, and/or memory 820. In some embodiments, processor 812 can be any suitable hardware processor or combination of processors, such as a CPU, a GPU, and so on. In some embodiments, display 814 can include any suitable display devices, such as an LCD screen, LED display, OLED display, electrophoretic display, a computer monitor, a touchscreen, a television, and so on. In some embodiments, inputs 816 can include any suitable input devices and/or sensors that can be used to receive user input, such as a keyboard, a mouse, a touchscreen, a microphone, and so on.

In some embodiments, communications systems 818 can include any suitable hardware, firmware, and/or software for communicating information over communication network 754 and/or any other suitable communication networks. For example, communications systems 818 can include one or more transceivers, one or more communication chips and/or chip sets, and so on. In a more particular example, communications systems 818 can include hardware, firmware, and/or software that can be used to establish a Wi-Fi connection, a Bluetooth connection, a cellular connection, an Ethernet connection, and so on.

In some embodiments, memory 820 can include any suitable storage device or devices that can be used to store instructions, values, data, or the like, that can be used, for example, by processor 812 to present content using display 814, to communicate with one or more computing devices 750, and so on. Memory 820 can include any suitable volatile memory, non-volatile memory, storage, or any suitable combination thereof. For example, memory 820 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 820 can have encoded thereon a server program for controlling operation of server 752. In such embodiments, processor 812 can execute at least a portion of the server program to transmit information and/or content (e.g., data, images, a user interface) to one or more computing devices 750, receive information and/or content from one or more computing devices 750, receive instructions from one or more devices (e.g., a personal computer, a laptop computer, a tablet computer, a smartphone), and so on.

In some embodiments, the server 752 is configured to perform the methods described in the present disclosure. For example, the processor 812 and memory 820 can be configured to perform the methods described herein (e.g., the method of FIG. 2, the method of FIG. 3).

In some embodiments, data source 702 can include a processor 822, one or more data acquisition systems 824, one or more communications systems 826, and/or memory 828. In some embodiments, processor 822 can be any suitable hardware processor or combination of processors, such as a CPU, a GPU, and so on. In some embodiments, the one or more data acquisition systems 824 are generally configured to acquire data, images, or both, and can include a CT system. Additionally or alternatively, in some embodiments, the one or more data acquisition systems 824 can include any suitable hardware, firmware, and/or software for coupling to and/or controlling operations of a CT system. In some embodiments, one or more portions of the data acquisition system(s) 824 can be removable and/or replaceable.

Note that, although not shown, data source 702 can include any suitable inputs and/or outputs. For example, data source 702 can include input devices and/or sensors that can be used to receive user input, such as a keyboard, a mouse, a touchscreen, a microphone, a trackpad, a trackball, and so on. As another example, data source 702 can include any suitable display devices, such as an LCD screen, an LED display, an OLED display, an electrophoretic display, a computer monitor, a touchscreen, a television, etc., one or more speakers, and so on.

In some embodiments, communications systems 826 can include any suitable hardware, firmware, and/or software for communicating information to computing device 750 (and, in some embodiments, over communication network 754 and/or any other suitable communication networks). For example, communications systems 826 can include one or more transceivers, one or more communication chips and/or chip sets, and so on. In a more particular example, communications systems 826 can include hardware, firmware, and/or software that can be used to establish a wired connection using any suitable port and/or communication standard (e.g., VGA, DVI video, USB, RS-232, etc.), Wi-Fi connection, a Bluetooth connection, a cellular connection, an Ethernet connection, and so on.

In some embodiments, memory 828 can include any suitable storage device or devices that can be used to store instructions, values, data, or the like, that can be used, for example, by processor 822 to control the one or more data acquisition systems 824, and/or receive data from the one or more data acquisition systems 824; to generate images from data; present content (e.g., data, images, a user interface) using a display; communicate with one or more computing devices 750; and so on. Memory 828 can include any suitable volatile memory, non-volatile memory, storage, or any suitable combination thereof. For example, memory 828 can include RAM, ROM, EPROM, EEPROM, other types of volatile memory, other types of non-volatile memory, one or more types of semi-volatile memory, one or more flash drives, one or more hard disks, one or more solid state drives, one or more optical drives, and so on. In some embodiments, memory 828 can have encoded thereon, or otherwise stored therein, a program for controlling operation of data source 702. In such embodiments, processor 822 can execute at least a portion of the program to generate images, transmit information and/or content (e.g., data, images, a user interface) to one or more computing devices 750, receive information and/or content from one or more computing devices 750, receive instructions from one or more devices (e.g., a personal computer, a laptop computer, a tablet computer, a smartphone, etc.), and so on.

In some embodiments, any suitable computer-readable media can be used for storing instructions for performing the functions and/or processes described herein. For example, in some embodiments, computer-readable media can be transitory or non-transitory. For example, non-transitory computer-readable media can include media such as magnetic media (e.g., hard disks, floppy disks), optical media (e.g., compact discs, digital video discs, Blu-ray discs), semiconductor media (e.g., RAM, flash memory, EPROM, EEPROM), any suitable media that is not fleeting or devoid of any semblance of permanence during transmission, and/or any suitable tangible media. As another example, transitory computer-readable media can include signals on networks, in wires, conductors, optical fibers, circuits, or any suitable media that is fleeting and devoid of any semblance of permanence during transmission, and/or any suitable intangible media.

As used herein in the context of computer implementation, unless otherwise specified or limited, the terms “component,” “system,” “module,” “framework,” and the like are intended to encompass part or all of computer-related systems that include hardware, software, a combination of hardware and software, or software in execution. For example, a component may be, but is not limited to being, a processor device, a process being executed (or executable) by a processor device, an object, an executable, a thread of execution, a computer program, or a computer. By way of illustration, both an application running on a computer and the computer can be a component. One or more components (or system, module, and so on) may reside within a process or thread of execution, may be localized on one computer, may be distributed between two or more computers or other processor devices, or may be included within another component (or system, module, and so on).

In some implementations, devices or systems disclosed herein can be utilized or installed using methods embodying aspects of the disclosure. Correspondingly, description herein of particular features, capabilities, or intended purposes of a device or system is generally intended to inherently include disclosure of a method of using such features for the intended purposes, a method of implementing such capabilities, and a method of installing disclosed (or otherwise known) components to support these purposes or capabilities. Similarly, unless otherwise indicated or limited, discussion herein of any method of manufacturing or using a particular device or system, including installing the device or system, is intended to inherently include disclosure, as embodiments of the disclosure, of the utilized features and implemented capabilities of such device or system.

The present disclosure has described one or more preferred embodiments, and it should be appreciated that many equivalents, alternatives, variations, and modifications, aside from those expressly stated, are possible and within the scope of the invention.

1. A method for generating images of a volume-of-interest (VOI) in a subject using a computed tomography (CT) system, the method comprising:
(a) accessing VOI image data with a computer system, wherein the VOI image data have been acquired from the VOI in the subject using the CT system and wherein the VOI image data include truncation artifacts;
(b) accessing a machine learning model with the computer system, wherein the machine learning model has been trained on training data to remove truncation artifacts from VOI images;
(c) inputting the VOI image data to the machine learning model using the computer system, generating output data as artifact-reduced VOI images that depict the VOI in the subject with reduced truncation artifacts as compared to the VOI image data; and
(d) displaying the artifact-reduced VOI images to a user or storing the artifact-reduced VOI images using the computer system.

2. The method of claim 1, wherein the VOI image data comprise VOI images obtained from the VOI of the subject.

3. The method of claim 1, wherein the VOI image data comprise projection data acquired from the VOI of the subject using the CT system.

4. The method of claim 3, wherein accessing the VOI image data with the computer system comprises accessing the projection data with the computer system, reconstructing VOI images from the projection data using the computer system, and storing the VOI images as the VOI image data.

5. The method of claim 1, wherein the machine learning model comprises a neural network.

6. The method of claim 5, wherein the neural network is a convolutional neural network.

7. The method of claim 6, wherein the convolutional neural network comprises a residual neural network architecture.

8. The method of claim 7, wherein the convolutional neural network comprises a 6-layer residual U-Net.

9. The method of claim 5, wherein the neural network is trained using supervised learning and the training data comprise matched pairs of image patches with truncation artifacts and without truncation artifacts.

10. The method of claim 1, wherein the VOI image data are acquired with the CT system using a VOI helical CT data acquisition.

11. The method of claim 1, wherein the VOI image data are acquired with the CT system using an axial acquisition geometry without patient table motion.

12. The method of claim 1, wherein the VOI image data are acquired with the CT system using an x-ray exposure targeted on the VOI so as to increase spatial resolution and reduce image noise in the VOI image data.
